(19) United States
(12) Patent Application Publication
(10) Pub. No.: US 2018/0207885 A1
(43) Pub. Date: Jul. 26, 2018

(54) THREE DIMENSIONAL PRINTING MECHANISM AND METHOD FOR PRINTING A THREE DIMENSIONAL OBJECT

(71) Applicant: Young Optics Inc., Hsinchu (TW)

(72) Inventors: Tsung-Yu Liu, Hsinchu (TW); Chao-Shun Chen, Hsinchu (TW); Chang-Chun Chen, Hsinchu (TW); Chia-jung Liu, Hsinchu (TW)

(21) Appl. No.: 15/498,989

(22) Filed: Apr. 27, 2017

(30) Foreign Application Priority Data
Jan. 25, 2017 (TW) 106102938

(51) Int. Cl. B29C 67/00; B29C 31/04; B33Y 10/00; B33Y 30/00

(52) U.S. Cl. CPC B29C 67/007; B29C 67/0092; B33Y 30/00; B29C 31/042; B33Y 10/00; B29C 67/0096

(57) ABSTRACT

A three dimensional printing mechanism includes a plane receiving a first photocured material and a second photocured material which is different from the first photocured material. A first photocured material supplying mechanism is used for inputting the first photocured material into the plane, whereas a second photocured material supplying mechanism is used for inputting the second photocured material into the plane.

### FIELD OF THE INVENTION

The invention relates to a printing apparatus and method for printing, and more particularly to a three dimensional printing mechanism and method for printing a three dimensional object.

### BACKGROUND OF THE INVENTION

A three dimensional printing apparatus for photocured molding comes out at present, in which the photocured molding is the technology of curing a photocured material for molding by the irradiation from a beam. However, some conventional three-dimensional printing apparatuses are unable to change the photocured material during the printing process, so that the conventional three-dimensional printing apparatus can only manufacture an object composed of one kind of material. Other conventional three-dimensional printing apparatuses which can change the photocured material during the printing process have complicated-structures and high cost.

### SUMMARY OF THE INVENTION

An embodiment of the present invention provides a three dimensional printing mechanism, including a plane can put a first photocured material and a second photocured material which is different from the first photocured material. A first photocured material supplying mechanism is used for inputting the first photocured material into the plane, whereas a second photocured material supplying mechanism is used for inputting the second photocured material into the plane.

An embodiment of the present invention provides a method for printing a three dimensional object which comprises the steps of putting a first photocured material on a plane, a pattern beam penetrating the plane and hitting the first photocured material to cure the first photocured material, cleaning the first photocured material from the plane, putting a second photocured material on the plane; and another pattern beam penetrating the plane and hitting the second photocured material to cure the second photocured material, wherein the first photocured material is different from the second photocured material.

The embodiment of the present invention with a simple structure can use at least two kinds of photocured materials for performing printing processes, so as to manufacture a three-dimensional object made of a variety of photocured materials because of the use of a plurality of supplying mechanisms (e.g. supplying pump or supplying tank), at least a container, and a photocured material draining mechanism.

The foregoing and other objects, features and advantages of the present invention can be further understood by the following detailed description in incorporation with the following drawings.

### BRIEF DESCRIPTION OF THE DRAWINGS

The present invention will become more readily apparent to those ordinarily skilled in the art after reviewing the following detailed description and accompanying drawings, in which:

FIG. 1 is a schematic view of the three dimensional printing mechanism according to an embodiment of the present invention;

FIGS. 2A to 2D are schematic views of the three dimensional printing apparatus of FIG. 1 in operation;

FIGS. 3A to 3D are schematic views of the three dimensional printing mechanism according to an another embodiment of the present invention;

FIG. 4 is a schematic view of the three dimensional printing mechanism according to yet another embodiment of the present invention; and

FIG. 5 is a schematic view of the three dimensional printing mechanism according to yet another embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

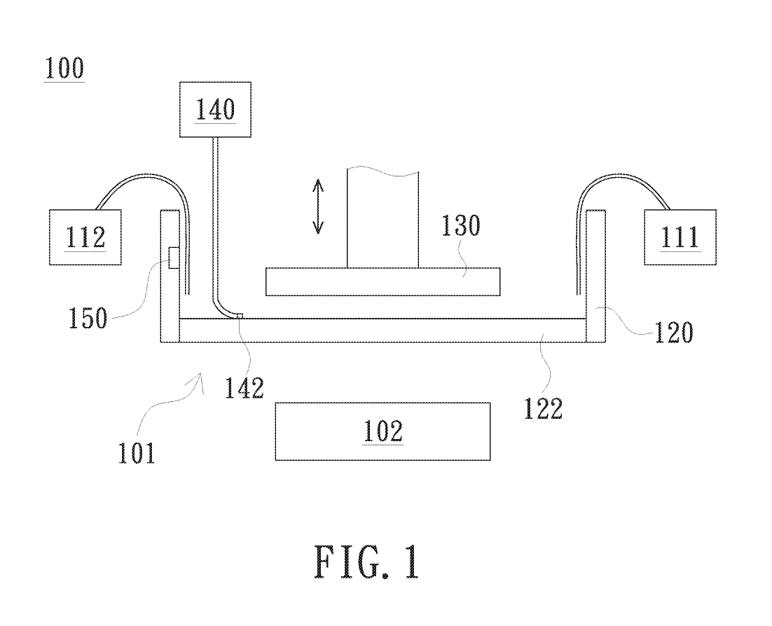

Referring to FIG. 1, FIG. 1 is a schematic view of a three dimensional printing apparatus 100. The three dimensional printing apparatus 100 includes a three dimensional printing mechanism 101, a projector 102, and a printing platform 130. The projector 102 may be disposed under the three dimensional printing mechanism 101, and can emit a beam to the three dimensional printing mechanism 101. The three dimensional printing mechanism 101 includes a container 120. The container 120 has a plane 122, which can be penetrated by the beam. The plane 122 is used for putting at least two different kinds of the photocured materials. The printing platform 130 is disposed above the projector 102, and can move towards or away from the container 120. In one of the embodiments, the projector 102 may be disposed above the three dimensional printing mechanism 101, whereas the printing platform 130 may be disposed under the projector 102. However, the present invention is not limited thereto.

The three dimensional printing mechanism 101 further includes a plurality of supplying mechanisms. Taking FIG. 1 for an example, the three dimensional printing mechanism 101 includes a first photocured material supplying mechanism 111 and a second photocured material supplying mechanism 112. The first photocured material supplying mechanism 111 and the second photocured material supplying mechanism 112 have a first output and a second output to supply two different kinds of the photocured materials to the plane 122 of the container 120, wherein the first and second outputs are above the plane 122. The three dimensional printing mechanism 101 may further include a photocured material draining mechanism 140 and a sensor 150, in which the photocured material draining mechanism 140 may be a draining pump and used for removing a part or all of the photocured material on the plane 122 by its drawing port which is disposed on the plane, while the sensor 150 can sense that whether the photocured material in the container 120 arrives at a set level for performing a printing process. The three dimensional printing mechanism 101 may further include a filter 142 installed in the photocured material draining mechanism 140, which is used for filtering the removed photocured material to remove the remains of cured fragment, in which the filter 142 is, for example, a strainer and may mounted at the a draining port of the photocured material draining mechanism 140. Generally, the common supplying mechanism of the three dimensional printing apparatus can supply the photocured material by the difference of pressure, such as common pump; by screw mechanism, such as Archimedes screw pump; by squeeze, such as stepper motor and a feed gear; by pressure, such as nozzle; or by adhesion, such as roller and the like, which are well known to one of ordinary skill in the art that. In addition, the state of photocured material may be liquid, colloid, fluid, powders, etc., but not limit the invention. The photocured material draining mechanism of the three dimensional printing apparatus can drain a part or all of the photocured material on the plane 122 by the difference of pressure or the screw mechanism, such as a pump or Archimedes screw pump. In addition, the plane 122 may be tilted, such that the gravity drives the photocured material to a recess. Then, an opened draining valve linking to the recess can drain the photocured material. Alternatively, the photocured material on the plane can be removed directly by mechanical means, such as a scraper or a high-pressure gas nozzle. The photocured material draining mechanism of the three dimensional printing apparatus contains a variety of embodiments, and does not limit the invention.

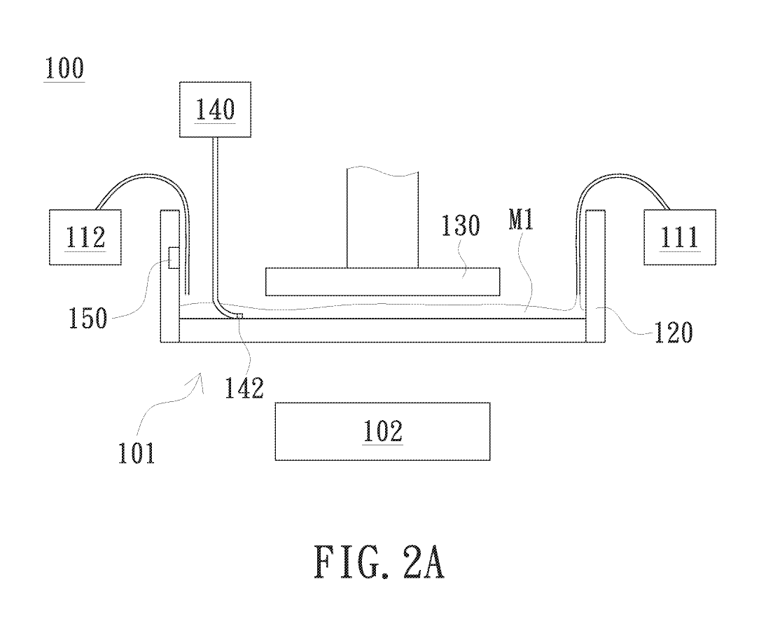

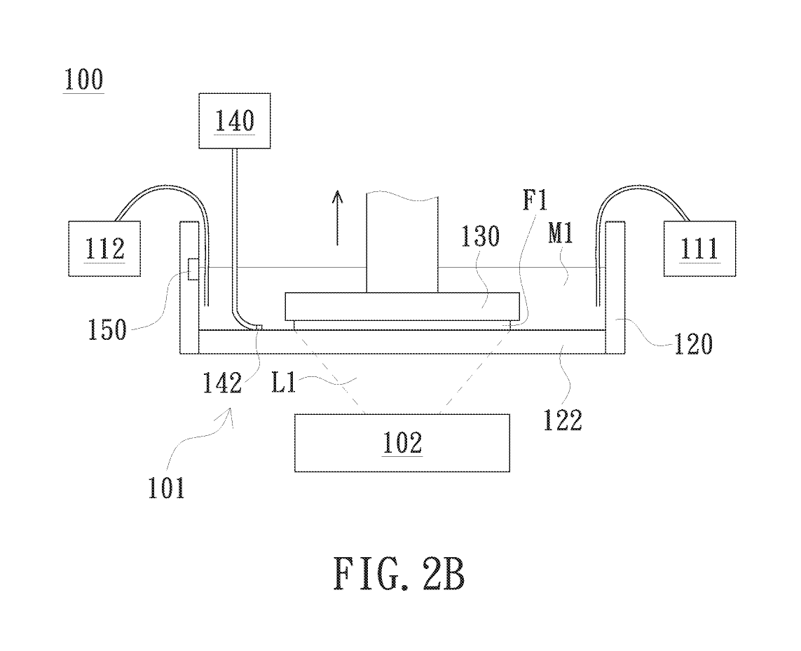

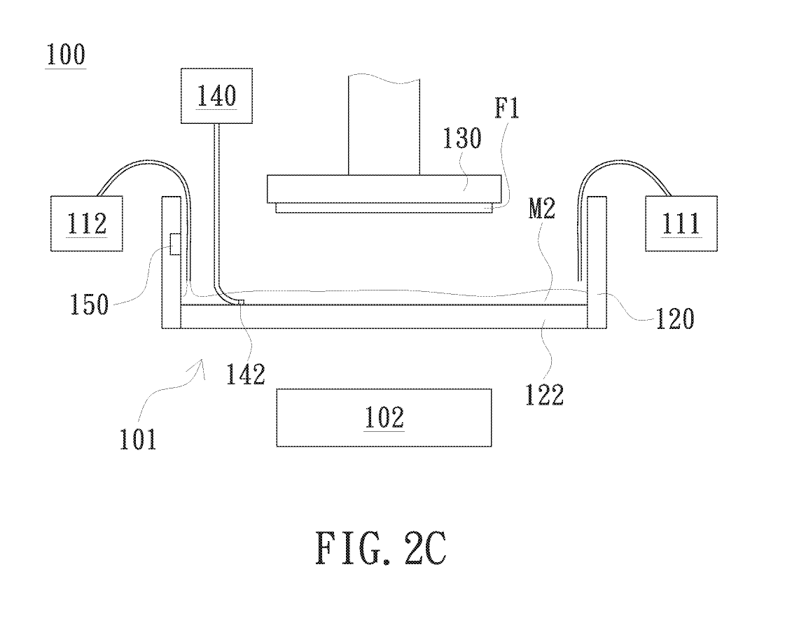

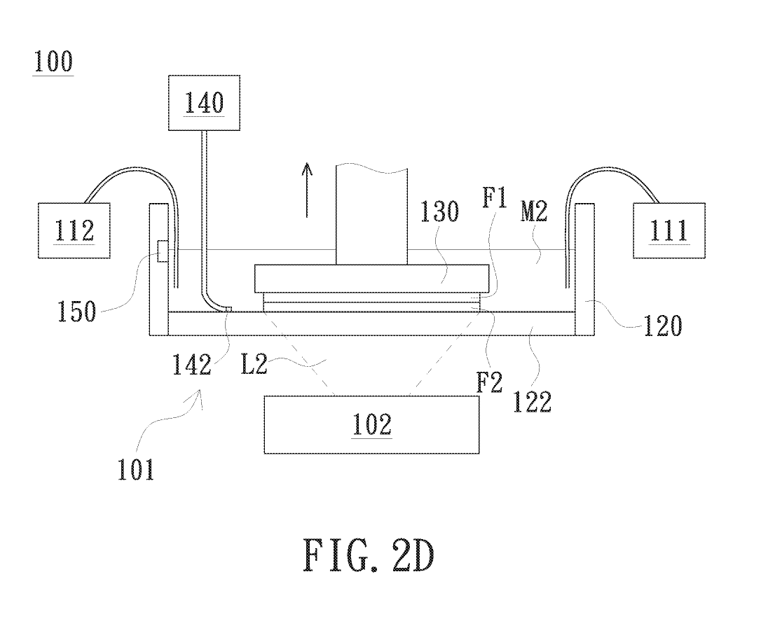

FIGS. 2A to 2D are schematic views of the three dimensional printing apparatus of FIG. 1 in operation. Referring to FIG. 2A and taking FIG. 2A for an example, during the printing process that the three dimensional printing apparatus 100 performs, first, the first photocured material supplying mechanism 111 (e.g. that supplying pump) supplies the first photocured material M1 into the container 120 until the sensor 150 senses that the first photocured material M1 arrives at the set level, which means that the container 120 is filled with enough first photocured material M1, so that the printing platform 130 can perform the printing process.

Referring to FIG. 2B, next, the projector 102 emits a pattern beam L1, while the pattern beam L1 penetrates the plane 122 and then, hits the first photocured material M1 to cure the first photocured material M1. Accordingly, the cured first photocured material M1 forms a first solid pattern F1 on the bottom of the printing platform 130. After the first solid pattern F1 is formed, the projector 102 stops emitting the pattern beam L1, and the printing platform 130 moves away from the projector 102. At this time, if it is necessary to use other photocured material for next printing step, the photocured material draining mechanism 140 (e.g. draining pump) removes the first photocured material M1 in the container 120. Then, the filter 142 filters the removed the first photocured material M1.

Referring to FIG. 2C, after removing the first photocured material M1 in the container 120, the second photocured material supplying mechanism 112 (e.g. supplying pump) supplies the second photocured material M2 into the container 120 to prepare next printing process. The first photocured material M1 is different from the second photocured material M2. In one of the embodiment, another first photocured material appearing a color that is different from the color of the first photocured material M1 may be regarded as a second photocured material, but the invention is not limited thereto. Referring to FIG. 2C, the second photocured material supplying mechanism 112 can keep supplying the second photocured material M2 into the container 120 until the sensor 150 senses that the second photocured material M2 arrives at the set level.

Referring to FIG. 2D, next, the projector 102 emits a pattern beam L2 to the plane 122. The pattern beam L2 penetrates the plane 122 and then, hits the second photocured material M2 to cure the second photocured material M2. Accordingly, the cured second photocured material M2 forms a second solid pattern F2 on the bottom of the first solid pattern F1. In one of the embodiments, the first solid pattern F1 and the second solid pattern F2 may also be formed on the same height level. After forming the second solid pattern F2, the projector 102 stops emitting the pattern beam L2. Then, the printing platform 130 moves away from the projector 102. At this time, if it is necessary to use other photocured material for next printing step, the photocured material draining mechanism 140 removes the second photocured material M2 in the container 120. Then, the filter 142 filters the removed the second photocured material M2.

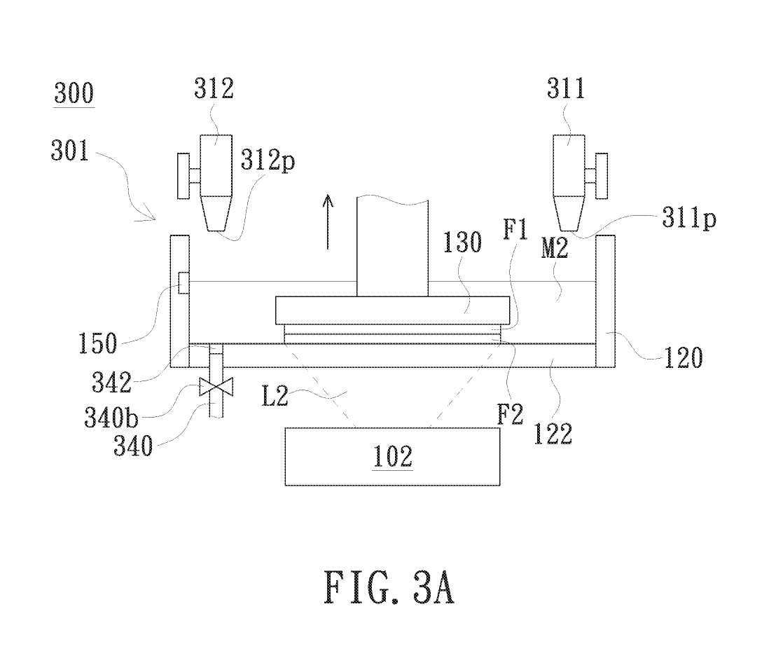

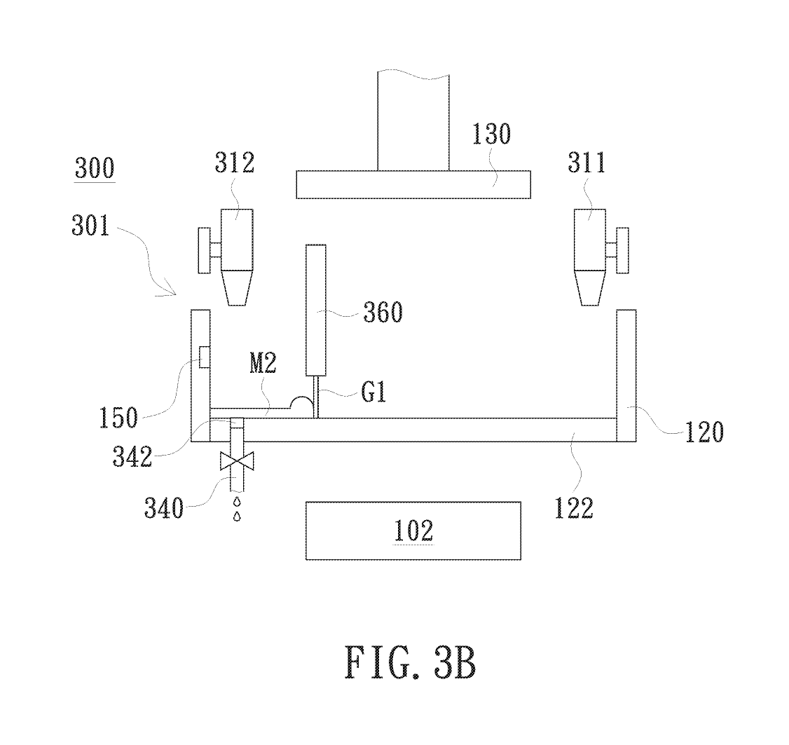

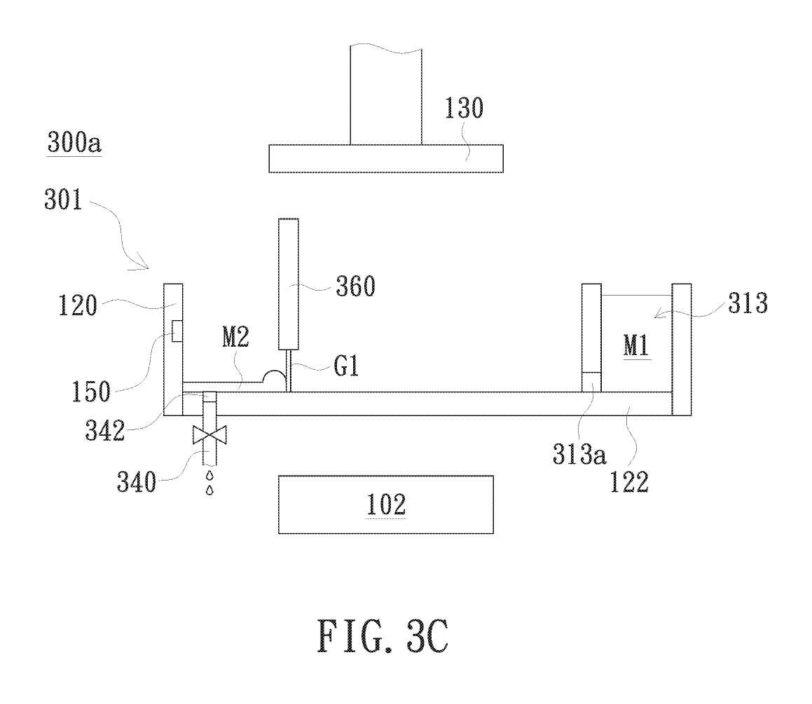

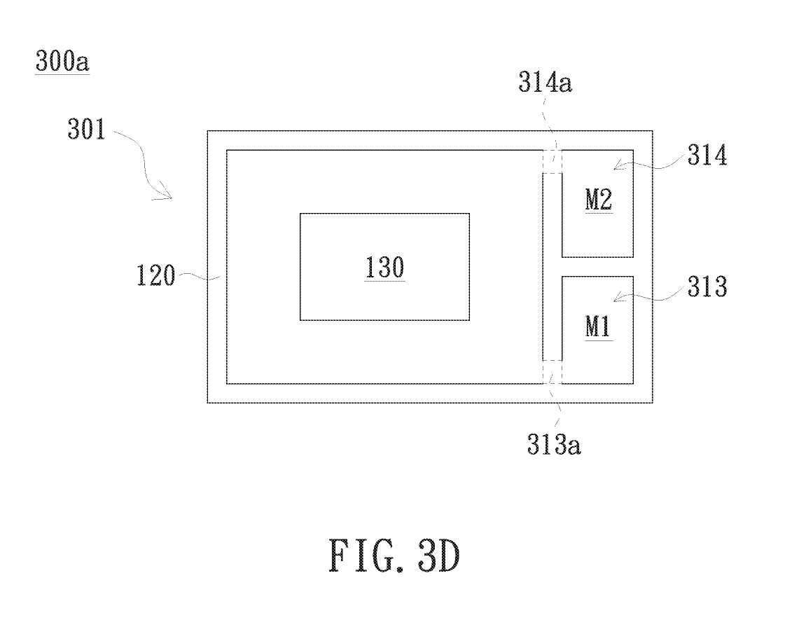

Referring to FIG. 3A, FIG. 3A is a schematic view of a three dimensional printing apparatus 300. The following describes the difference between the three dimensional printing mechanisms 301 and 101 without repeating the same of both.

The three dimensional printing mechanism 301 includes a plurality of supplying mechanisms, for example a first photocured material supplying tank 311 and a second photocured material supplying tank 312. The first photocured material supplying tank 311 supplies the first photocured material M1 (not shown in FIG. 3A) from a first supplying port 311p into the container 120 by gravity, and the second photocured material supplying tank 312 supplies the second photocured material M2 from a second supplying port 312p into the container 120 by gravity, in which both the first photocured material supplying port 311p and the second photocured material supplying port 312p are located above the container 120.

In one of the embodiments, the first photocured material supplying tank 311 and the second photocured material supplying tank 312 can use an assisted device, such as pump, to help to supply the photocured material, but the invention is not limit thereto. In one of the embodiments, the first photocured material supplying tank 311 and the second photocured material supplying tank 312 each has a control valve, so as to control the supply of the first photocured material M1 and the second photocured material M2 into the container 120, in which the control valve, for example, may be a solenoid valve, but the invention is not limited thereto. The control valve can be controlled by manual control or other means.

The three dimensional printing mechanism 301 further includes a photocured material draining mechanism 340. In one of the embodiments, the photocured material draining mechanism 340 is a draining valve 340b mounted in the container 120, not pump, and the photocured material draining mechanism 340 is under the bottom of the container 120. When the photocured material draining mechanism 340 is started, the photocured material in the container 120 flows from the photocured material draining mechanism 340 by gravity. Thus, the photocured material draining mechanism 340 can remove the photocured material in the container 120 by gravity without any power source, such as motor and pump. In one of the embodiments, an assisted device, such as pump, can be used to help to remove the photocured material, but the invention is not limited thereto. In addition, the three dimensional printing mechanism 301 further includes a filter 342 mounted in the photocured material draining mechanism 340, and the filter 342 is used for filtering the removed photocured material and may be a strainer, for example.

Referring to FIG. 3B, the three dimensional printing mechanism 301 may further include a clean nozzle 360 for removing the photocured material on the plane 122. Taking FIG. 3B for an example, the clean nozzle 360 can generate a jet gas flow G1, which can blow the second photocured material M2 (or the first photocured material M1). Moving the clean nozzle 360 can make the jet gas flow G1 blow the remains of the second photocured material M2 to the photocured material draining mechanism 340, so that the remains of the second photocured material M2 can be drained from the photocured material draining mechanism 340. In addition, the previous three dimensional printing mechanism 101 also may include the clean nozzle 360. That is, the photocured material draining mechanism 140 in FIG. 1 can use the clean nozzle 360 for cleaning and removing the photocured material in the container 120.

Additionally, the abovementioned three dimensional printing mechanisms 101 and 301 each include two mechanisms for supplying two kinds of the photocured materials into the container 120 (e.g. supplying pump and supplying tank), but in one of the embodiments, the three dimensional printing mechanisms 101 and 301 each also may include three or more than three supplying mechanisms. Thus, the number of the supplying pumps that the three dimensional printing mechanism 101 includes is not limited to just two. Likewise, the number of the supplying pumps that the three dimensional printing mechanism 301 includes is not limited to just two.

Referring to FIGS. 3C and 3D, FIG. 3C is a schematic view of a three dimensional printing mechanism 300a, and FIG. 3D is a top view of the three dimensional printing mechanism 300a of FIG. 3C. The difference between the three dimensional printing mechanisms 300a and 300 exists, and the following describes the difference without repeating the same of both.

The three dimensional printing mechanisms 300a includes a first photocured material supplying tank 313 and a second photocured material supplying tank 314. The first photocured material supplying tank 313 and the second photocured material supplying tank 314 are integrated with the three dimensional printing mechanisms 301. The container 120 may be connected to the first photocured material supplying tank 313 and the second photocured material supplying tank 314, wherein the container 120, the first photocured material supplying tank 313, and the second photocured material supplying tank 314 may be integrally formed into one. Alternatively, the first photocured material supplying tank 313 and the second s photocured material supplying tank 314 may be independent parts outside the container 120.

The first photocured material supplying tank 313 and the second photocured material supplying tank 314 can hold the first photocured material M1 and the second photocured material M2. The first photocured material supplying tank 313 and the second photocured material supplying tank 314 have an opening 313a and an opening 314a, where the opening 313a and the opening 314a are formed above the plane 122. In addition, there are two valves mounted in the opening 313a and the opening 314a to control supplying the the first photocured material M1 and the second photocured material M2 by gravity.

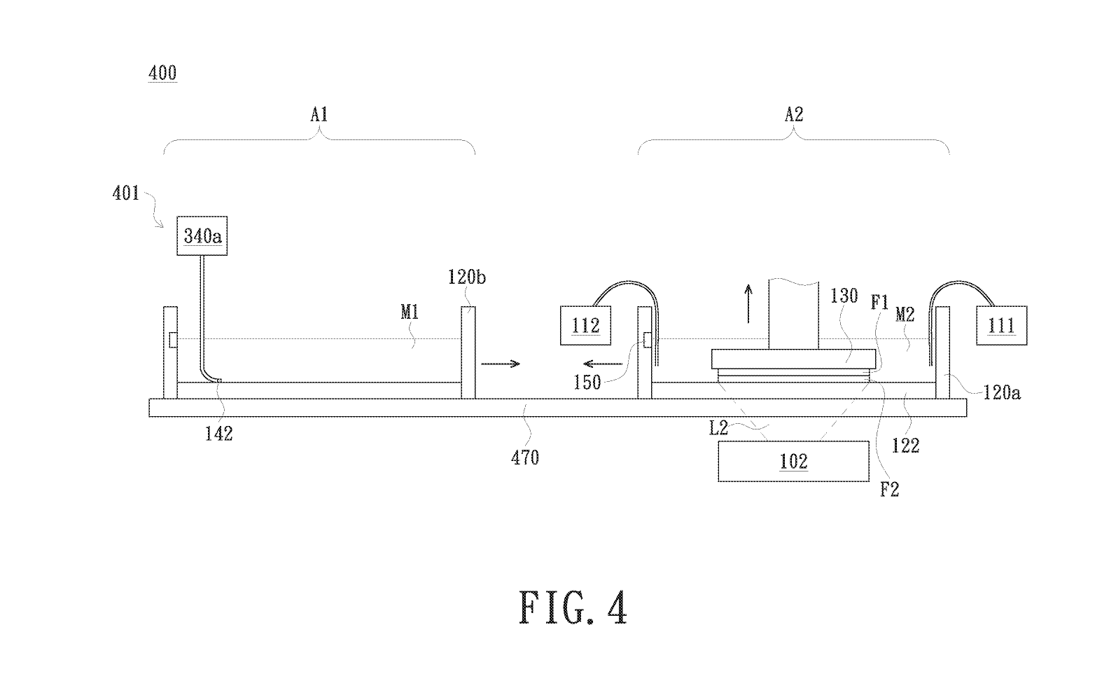

Referring to FIG. 4, FIG. 4 is a schematic view of the three dimensional printing apparatus 400. The difference between the three dimensional printing mechanisms 401 and 101 exists, and the following describes the difference without repeating the same of both.

The three dimensional printing mechanism 401 includes two containers: a first container 120a and a second container 120b. The first container 120a and the second container 120b are used for holding different photocured materials respectively and placed within a non-printing area A1 and a printing area A2 separately.

The draining pump 340a in the non-printing area A1 is used for removing the photocured material in the second container 120b that is placed within the non-printing area A1. The first photocured material supplying mechanism 111, the second photocured material supplying mechanism 112, the printing platform 130, and the projector 102 are all placed within the printing area A2. The first photocured material supplying mechanism 111, the second photocured material supplying mechanism 112, and the printing platform 130 are all located above the plane 122 in printing state. The three dimensional printing mechanism 401 may further include a transporting device 470, such as slippery track or rotational platform. In one of the embodiments, the transporting device 470 is disposed under the first container 120a and the second container 120b, but the invention is not limited thereto. The transporting device 470 can move the first container 120a and the second container 120b, such that the first container 120a and the second container 120b can be shifted between the non-printing area A1 and the printing area A2.

The operation of the three dimensional printing apparatus 400 is similar to the operation of abovementioned three dimensional printing apparatus 100. However, the printing platform 130 and the projector 102 are all placed within the printing area A2. Consequently, the three dimensional printing apparatus 400 performs the whole printing process within the printing area A2, whereas the printing process is not performed within the non-printing area A1. Taking FIG. 4 for an example, after the first photocured material M1 is irradiated by the pattern beam L1 to form the first solid pattern F1, the transporting device 470 moves the second container 120b previously holding the first photocured material M1 from the printing area A2 to the non-printing area A1, whereas the transporting device 470 moves the first container 120a to the printing area A2 when the subsequent process needs another photocured material.

Afterwards, the draining pump 340a removes the first photocured material M1 in the second container 120b placed within the non-printing area A1. The draining pump 340a and the clean nozzle 360 (referring to FIG. 3B) can work together to remove the first photocured material M1. Meanwhile, the second photocured material supplying mechanism 112 supplies the second photocured material M2 into the first container 120a placed within the printing area A2, until the sensor 150 senses that the second photocured material M2 arrives at the set level. Next, the projector 102 emits the pattern beam L2, so as to form the second solid pattern F2 on the bottom of the first solid pattern F1. After forming the second solid pattern F2, the transporting device 470 moves the first container 120a holding the second photocured material M2 from the printing area A2 to the non-printing area A1 when the subsequent process needs another photocured material.

The transporting device 470 moves the clean second container 120b after the removal of the first photocured material M1 from the non-printing area A1 to the printing area A2, in which the second container 120b holds the first photocured material M1 from the first photocured material supplying mechanism 111 at this time, so as to perform the subsequent printing process again. Meanwhile, the draining pump 340a removes the second photocured material M2 in the first container 120a placed within the non-printing area A1. Therefore, the first container 120a and the second container 120b can be shifted between the non-printing area A1 and the printing area A2, so that a plurality of the printing processes can be performed until a printing finished product is complete.

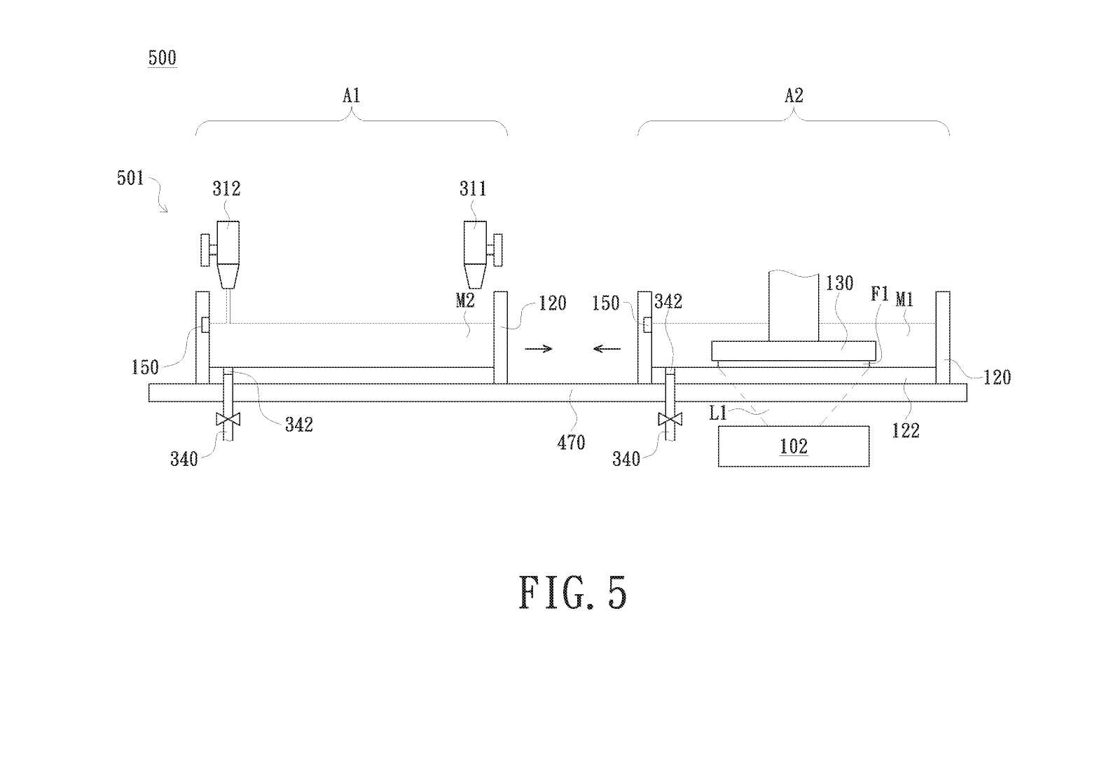

Referring to FIG. 5, FIG. 5 is a schematic view of three dimensional printing apparatus 500. Unlike the three dimensional printing mechanism 401, in the three dimensional printing mechanism 501, the first photocured material supplying tank 311 and the second photocured material supplying tank 312 are all placed within the non-printing area A1, whereas the printing platform 130 and the projector 102 are all placed within the printing area A2. According, the three dimensional printing apparatus 500 performs whole printing processes within the printing area A2. The first photocured material supplying tank 311 and the second photocured material supplying tank 312 are all placed within the non-printing area A1, so that the supply and the removal of the first photocured material M1 and the second photocured material M2 are all performed within the non-printing area A1. Therefore, when the container 120 within the the printing area A2 is in the printing process, the supply and the removal of the photocured material can be performed to the container 120 within the non-printing area A1 meanwhile.

Taking FIG. 5 for an example, when the projector 102 within the printing area A2 emits the pattern beam L1 for the formation of the first solid pattern F1, the second photocured material supplying tank 312 within the non-printing area A1 starts to supply the second photocured material M2 into the container 120 in the meanwhile for shortening the time that the printing process needs to be finished, thereby increasing the throughput of the three dimensional printing apparatus 500.

In sum, an embodiment of the invention can use at least two different kinds of the photocured materials or two photocured materials respectively appearing two different colors for printing processes by a plurality of the supplying mechanisms (e.g. supplying pumps or supplying tanks or other supplying apparatus), at least one container and a photocured material draining mechanism, thereby manufacturing a three-dimensional object composed of a variety of solid patterns (or having a variety of colors). Compared to the complicated conventional three-dimensional printing apparatus, an embodiment of the invention can use the abovementioned simple three dimensional printing apparatus to manufacture more various objects for various demands.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A three dimensional printing mechanism, comprising:
a plane, putting a first photocured material and a second photocured material, wherein the first photocured material is different from the second photocured material:
a first photocured material supplying mechanism, having a first output above the plane to supply the first photocured material to the plane; and
a second photocured material supplying mechanism, having a second output above the plane to supplying the second photocured material to the plane.

2. The three dimensional printing mechanism according to claim 1, further comprising a photocured material draining mechanism having a drawing port on the plane to remove at least one of a part of the first photocured material and a part of the second photocured material on the plane.

3. The three dimensional printing mechanism according to claim 2, wherein the photocured material draining mechanism is selected from a group consisting of a pump, an Archimedes screw pump, a draining valve, a scraper, and a high-pressure gas nozzle.

4. The three dimensional printing mechanism according to claim 2, further comprising a filter mounted in the photocured material draining mechanism.

5. The three dimensional printing mechanism according to claim 1, further comprising a clean nozzle.

6. The three dimensional printing mechanism according to claim 1, wherein the first photocured material supplying mechanism is selected from a group consisting of a common pump, an Archimedes screw pump, a stepper motor, a feed gear, a nozzle, a roller, and a supplying tank.

7. A three dimensional printing mechanism, comprising:
a first container, placed within a printing area, and holding a first photocured material;
a second container, placed within a non-printing area, holding a second photocured material, wherein the first photocured material is different from the second photocured material; and
a photocured material draining mechanism, having a drawing port removing the second photocured material in the second container.

8. The three dimensional printing mechanism according to claim 7, further comprising a transporting device shifting the first container and the second container between the printing area and the non-printing area.

9. The three dimensional printing mechanism according to claim 7, further comprising a first photocured material supplying mechanism that is selected from a group consisting of a common pump, an Archimedes screw pump, a stepper motor, a feed gear, a nozzle, a roller, and a supplying tank.

10. The three dimensional printing mechanism according to claim 7, further comprising a clean nozzle.

11. The three dimensional printing mechanism according to claim 7, wherein the photocured material draining mechanism is selected from a group consisting of a pump, an Archimedes screw pump, a draining valve, a scraper, or a high-pressure gas nozzle.

12. A method for printing a three dimensional object, comprises the steps of:
putting a first photocured material on a plane;
a pattern beam penetrating the plane and hitting the first photocured material to cure the first photocured material;
cleaning the first photocured material from the plane;
putting a second photocured material on the plane; and
another pattern beam penetrating the plane and hitting the second photocured material to cure the second photocured material, wherein the first photocured material is different from the second photocured material.

13. The method according to claim 12, wherein the step of putting the first photocured material performs by a first photocured material supplying mechanism, having a first output above the plane.

14. The method according to claim 12, further comprises the step of:
removing at least one of a part of the first photocured material and a part of the second photocured material by a clean nozzle.

15. The method according to claim 12, further comprises the step of:
removing at least one of a part of the first photocured material and one of a part of the second photocured material by a photocured material draining mechanism, having a drawing port.

16. The method according to claim 15, wherein the photocured material draining mechanism is selected from a group consisting of a pump, an Archimedes screw pump, a draining valve, a scraper, and a high-pressure gas nozzle.

17. The method according to claim 15, further comprises a filter mounted in the photocured material draining mechanism.

18. The method according to claim 12, further comprises the step of:
holding the first photocured material on a first container; and
holding the second photocured material on a second container, wherein the first container is different from the second container.

19. The method according to claim 18, further comprises the step of:
shifting the first container and the second container between a printing area and a non-printing area.

20. The method according to claim 12, wherein the first photocured material supplying mechanism is selected from a group consisting of a common pump, an Archimedes screw pump, a stepper motor, a feed gear, a nozzle, a roller, and a supplying tank.
